(19) United States
(12) Patent Application Publication
(10) Pub. No.: US 2020/0383307 A1
(43) Pub. Date: Dec. 10, 2020

(54) Compound Taper Fly Line

(71) Applicant: Hsichuan Hsieh, Cupertino, CA (US)

(72) Inventor: Hsichuan Hsieh, Cupertino, CA (US)

(21) Appl. No.: 16/433,509

(22) Filed: Jun. 6, 2019

(51) Int. Cl. A01K 91/12

(52) U.S. Cl. CPC A01K 91/12

(57) ABSTRACT

A fly line whose shape comprises an intermediary tapered section connecting a maximum thickness section to a minimum thickness tapered section; the sections comprising of a flexible outer coating bonded onto a flexible core; the intermediary tapered section is tapered in a manner that removes weight from the minimum thickness tapered section while adding weight to the maximum thickness section, whereby when used in conjunction with a rod results in an improved fly line dynamics and rod response.

The following is a tabulation of some prior art that presently appears relevant:

U.S. Patents

| Patent Number | Kind Code | Issue Date | Patentee |
|---|---|---|---|
| U.S. Pat. No. | | Jun. 25, 1985 | Wulff |
| 4,524,540 | | | |
| US 2003/0041502 | A1 | Mar. 6, 2003 | Mauri et al |
| U.S. Pat. No. | B1 | Jul. 16, 2002 | Shinagawa |
| 6,418,660 | | | |

Non Patent Literature Documents

### BACKGROUND

Fly line design is a delicate balance between several competing performance needs. This is particularly so for fly lines used in a type of casting called Spey where the fly line does not aerialize horizontally on the back cast. Rather, the back cast of a Spey fly line takes a C shape where the bottom of the C shape is in contact with the water surface, the belly of the C shape largely assumes a position behind the caster, and the top end of the C is connected to a rod that propels it forward.

The generic anatomy of a Spey fly line is a Belly section that is closest to the fly rod tip, followed by a Mid section, followed by a Front taper that has a fly connected to its free end with either a leader or another section of fly line.

The idealized performance balance of a Spey fly line is as such: 1) sufficient belly weight to facilitate easy casting of a rod, 2) sufficient transition of mid section to transfer belly energy to the front taper section without egregious loss of line ‘loop’ speed, 3) sufficient front taper mass to completely straighten out the fly as the fly line completely straightens out.

This delicate balance comes easily to light when the line is not balanced properly where some of the idealized belly weight is redistributed to rest of the line. In this compromised situation when the front taper mass is now heavier and thicker, making it more than ample to straighten out the fly at the end of the cast, the starved out belly weight now does not load the rod. This insufficient loading of the rod causes more work for the caster as the caster experiences a loss of idealized fly line speed, causing him to stroke the rod even faster than his muscle is comfortable performing at. This loss of line speed also then cannot turn over the fly, a turnover loss further compounded by now heavier mid and front taper sections.

Inversely, if some of the idealized front taper mass is redistributed to the other sections of the fly line, the now overweight belly will cause the rod to lose its idealized recovery speed. This leads to a slower belly section line speed. Although the lighter front taper mass will need less energy to turn over than its idealized former self, this advantage cannot make up for the slower belly section.

The mid section plays an important part in transferring energy from the belly to the front taper. Also, the mid section must be such that it ensures the maximum uncurling of the fly line loop speed. Since the belly section is often the thickest portion and the front taper is the thinnest portion of the fly line, the mid section needs to step down between these sections, either in a continuous tapered manner or in a stepped manner. The advantage of a continuous tapered manner, aside from a smooth transfer the energy between the sections, is 1) the continuous taper will have the ability to remain airborne longer due to it generating an air lift inflight as this section unrolls, 2) an rolling loop that is tapered has less air resistant as well as it is mechanically faster in turning over. The additional advantage of a stepped manner is the ability to have more weight closer to the belly—and thus rod tip—as well as a greater efficacy in energy transfer to the front taper section. Although this makes it easier to load the rod, the stepped taper has less airborne dynamics and remain less airborne, reducing distance the fly can travel.

An additional benefit is to have the center of mass of the line as close as possible to the rod tip. This increases the casters ability to steer the line especially post straightened fly line that now has to be prepped for the next forward cast by manipulating it to form a ‘C’ shape for the next cast. The closer this center of mass is to the rod tip, the easier it is to perform this preparatory manipulation.

In reference to a FIG. 1 embodiment as shown in U.S. Pat. No. 4,524,540 issued on Jun. 25, 1985 to Wulff, this Wulff embodiment does not meet the challenges of easy casting (the belly section is tapered, which pushes the fly line center of mass forward), of easy preparatory ‘C’ shape manipulation between casts (center of mass is inherently forward due to continuous taper), of the need for high uncurling loop speed (the slope of the taper is fixed throughout the length of the line, often driven by the need to minimize the loss of belly mass and not by the front taper uncurling speed), and of the mid section having a unique taper independent of the belly and front tapers (one fixed taper gradient throughout the line).

In reference to the above FIG. 2 embodiment as shown in U.S. Pat. No. 6,418,660 B1 issued on Jul. 16, 2002 to Shinagawa, this Shinagawa embodiment does not meet the challenges of easy casting (the long rear taper places the center of mass substantially forward in the non tapered area), of easy preparatory ‘C’ shape manipulation between casts (the center of mass is substantially forward in the non tapered area), of the need for high uncurling loop speed (the slope of the taper is driven by the thickness of the non tapered section—addressing the need to load the rod—and not by the need for the fly to straighten out as the fly line straightens out completely), and of the mid section having a unique taper independent of the belly and front tapers (the line only has a long rear taper, a belly, and a front taper).

Although Shinagawa embodiment places the center of mass next to the front taper for more efficient transfer of energy, this much forward belly requires slower action rods, actions that are outdated in today's fast action rods. Incidentally, it is still possible to use Shinagawa embodiment with today's fast action rods. However, this would entail pulling the rear taper into the rod guides until the non tapered belly is sufficiently close to the rod tip. This unfortunately shortens the line, reducing its distance carrying capacity as well as causing erratic casting performance (less line to stick to water). This is not an optimal compromise.

In reference to the above FIG. 3 embodiment as shown in Patent US 2003/0041502 issued on Mar. 6, 2003 to Mauri et al, this Mauri embodiment was designed for aerializing the fly line rather than the ‘C’ spey configuration between spey casts. Hence the Mauri configuration is such that it is a reverse in design. The fattest part of Mauri's embodiment is its fly end, whereas the fattest part needed for the spey cast should be the rod tip end. The Mauri embodiment does not anticipate using its embodied fly taper in reverse, and thus is not analogous to this application.

In reference to FIG. 4, an anatomy of a modern day Spey fly line is shown from the side. The substantial size of its mid section, located near the bottom half of a ‘C’ shape line configuration setup between casts, adds unneeded dead weight for the rod to work against. This extra weight slows down the fly line's ability to accelerate. This slower line response also slows down a rod's ability to recover, especially with modern fast action rod. Also, this substantial mid section size will not allow the fly line and fly to have a clean release, a feeling where the caster no longer feels the resistance of the fly line and fly beyond a certain expected point in his forward cast. This combination need for a clean release and for matching the line balance to the rod frequency often leave the caster experiencing a lighter and snappier feel of the rod, a higher performance feel that is often the Holy Grail that casters are willing to pay for.

### Advantages

Accordingly, several advantages of one or more aspects are as follows: a balanced fly line that such: 1) it has sufficient belly weight to facilitate easy casting of a rod, 2) it has a sufficient transition of mid section to transfer belly energy to the front taper section while generating line ‘loop’ speed, 3) it has sufficient front taper mass to completely straighten out the fly as the fly line completely straightens out, and 4) it has a line balance, especially by having a severe enough transition of mid section, that the caster feels a lighter and cleaner rod performance.

### DRAWINGS—FIGURES

Notice: A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

FIGS. 1 to 3 illustrates the illustrations of Prior Art as reference;

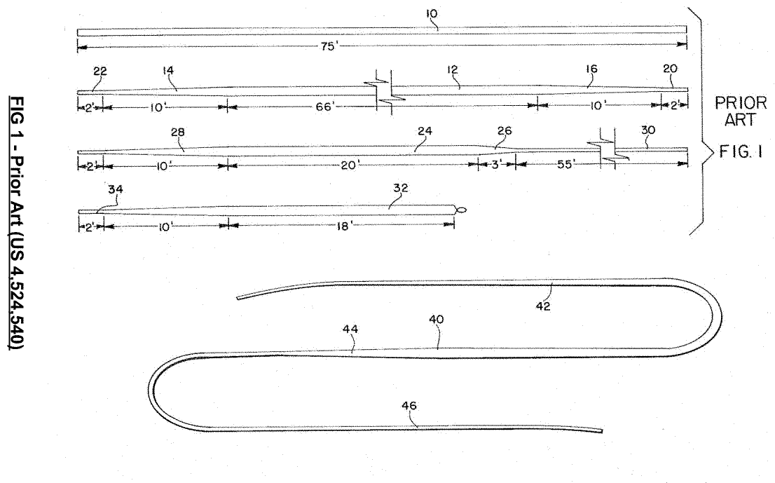

FIG. 4 illustrates a side view of a current fly line;

FIG. 5 illustrates a side view of improved fly line showing current invention;

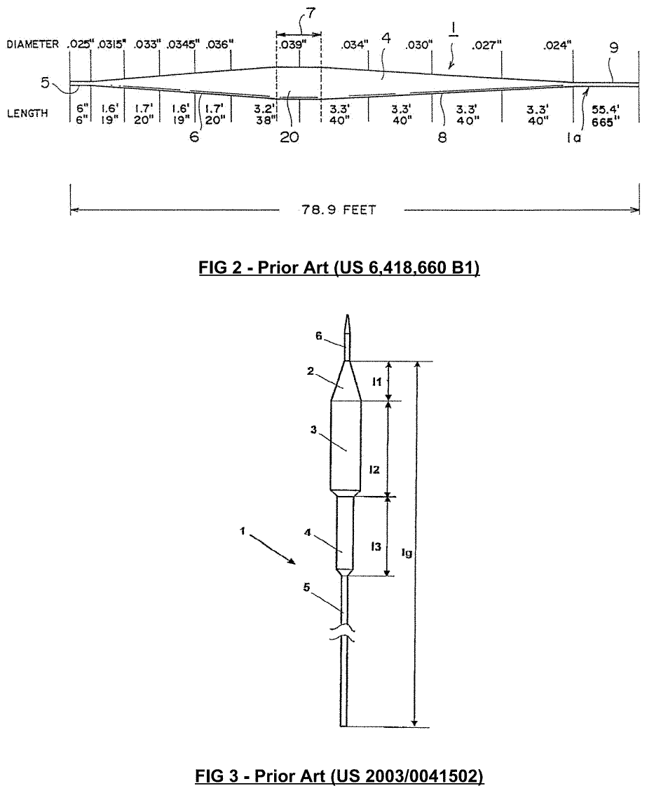

FIG. 4 Drawing—Reference Number

| | |
|---|---|
| 100 | Fly Line Head |
| 110 | Belly |
| 120 | Front Taper |
| 140 | Back Taper |
| 400 | Front Loop |
| 410 | Back Loop |
| 500 | Flexible Outer Coating |

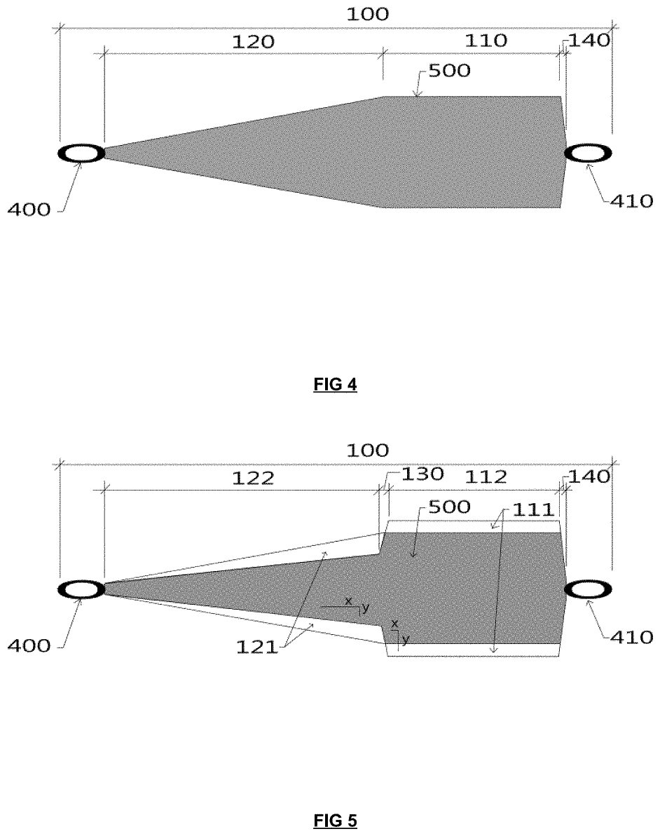

FIG. 5 Drawing—Reference Number

| | |
|---|---|
| 100 | Fly Line Head |
| 111 | Added Belly Weight |
| 112 | New Belly |
| 121 | Removed Front Taper Weight |
| 122 | Improved Front Taper |
| 130 | Funnel Taper |
| 140 | Back Taper |
| 400 | Front Loop |
| 410 | Back Loop |
| 500 | Flexible outer Coating |

### SUMMARY

### Embodiment

A balanced fly line such that it has sufficient belly weight to facilitate easy casting of a rod, it has a sufficient transition of mid section to transfer belly energy to the front taper section while generating line ‘loop’ speed, it has sufficient front taper mass to completely straighten out the fly as the fly line completely straightens out, and that it has a line balance, especially in the mid section, that the caster feels a lighter and cleaner rod performance.

### Detailed Description of Main Embodiment, FIGS. 4 and 5

While the configurations according to the illustrated embodiment are preferred, it is envisioned that alternate configurations of the present invention may be adopted without deviating from the invention as portrayed.

The preferred embodiments are discussed hereafter.

Referring first to FIG. 4, a Fly Line Head 100 comprises of 1) a Belly 110, 2) a Front Taper 120, 3) a Back Taper 140, 4) a Flexible Outer Coating 500, and 6) a Flexible core (not shown). Currently, the fly line head 100 is manufactured wherein the flexible outer coating 500 is a symmetrically cylindrical around the flexible core 600, with the belly 110, front taper 120, and back taper 140 manufactured in one contiguous process as tapered/non tapered sections of the fly line head 100.

It is currently contemplated that the flexible outer coating 500 is either Poly Vinyl Chloride (PVC) or Polyurethane (PU). Other flexible coating material can be considered. It is currently contemplated that the flexible core is braided Dacron. Other flexible core material and configuration can be considered.

The current manufacturing process bonds the flexible outer coating 500 onto the flexible core coating. The flexible outer coating 500 serves as necessary weight to load a suitable fly rod. The flexible core serves to provide the needed tensile strength to fight a fish, bypassing such stress from the flexible outer coating 500 for plastic polymers are not nearly as strong as the core.

The fly line head 100 has the option of having a Front Loop 400, and a Rear Loop 410. The front loop 400 connects to a fly (not shown) by means of a leader (not shown) or by means of an ancillary fly line (not shown). The rear loop 410 connects the fly line head 100 to a Running Line (not shown) that winds around a Reel (not shown). The loops 400 and 410 make provide the convenience to remove any attaching lines from the fly line head 100 quickly. In the absence of the loops 400 and 410, the leader or the ancillary fly line can be attached directly onto the front loop 400 by method of a nail knot; the running line can also be attached to the rear loop 410 by method of a nail knot. An Integral version of this complete setup for fishing, a version not shown here but is mentioned as a variant, is where the running line is manufactured as part of the fly line head 100, and whereas on the other end the ancillary fly line is also manufactured as part of the fly line head 100; all the above mentioned contiguous parts as one continuous piece.

The current invention improves on the design of FIG. 4. This improvement is illustrated in FIG. 5. The overall modification is by removing weight from the front taper and redistributing portions or all of this removed weight into the belly section. Weight removed from the front taper 120 can be seen as Removed Weight 121. Conversely, weight is added to the belly 110 can be seen as Added Belly Weight 111, resulting in a New Belly 112.

The change to both front taper 120 and the belly 110 changes the intermediary section connecting them both; producing a Funnel Taper 130. In contrasts to the unmodified fly line of FIG. 4, the funnel taper 130 has a shorter but steeper transition. This feature is key to providing the improved fly line performance captured in the Advantages section above.

The changes to the fly line in FIG. 5 are controlled in a unique relationship as tabled below:

| Length of the fly | Approx. weight removed | Approx. weight increased |
|---|---|---|
| fishing line 100 | 121 in the front taper 120 | 111 in the belly 110 |
| (feet) | (grains) | (grains/foot) |
| 73 to 90 | 120.0 | 3.5 |
| 62 to 73 | 80.0 | 3.0 |
| 50 to 62 | 73.0 | 3.0 |
| 42 to 50 | 53.0 | 2.0 |
| 37 to 42 | 43.0 | 2.0 |
| 22 to 37 | 22.0 | 2.0 |
| 15 to 22 | 18.0 | 2.0 |

The Funnel Taper is controlled in a unique relationship as tabled follow:

| Length of the | | Funnel Taper | Funnel Taper unit | |
|---|---|---|---|---|
| fly line head | Belly unit | slope range | weight change | Total Front Taper |
| range | weight range | (vertical | (heaviest to Lightest) | weight range |
| (feet) | (grains per foot) | unit:Horizontal unit) | (grains per foot) | (grains) |
| From 73 to 90 | From 25.0 to 27.0 | From 1:0 to 1:0.5 | From 6 to 8 | From 455 to 495 |
| From 62 to 73 | From 21.5 to 23.5 | From 1:0 to 1:0.5 | From 6 to 8 | From 390 to 420 |
| From 50 to 62 | From 22.0 to 24.0 | From 1:0 to 1:0.5 | From 6 to 8 | From 343 to 377 |
| From 42 to 50 | From 23.5 to 25.5 | From 1:0 to 1:0.5 | From 6 to 8 | From 300 to 340 |
| From 35 to 42 | From 24.0 to 26.0 | From 1:0 to 1:0.5 | From 6 to 8 | From 250 to 290 |
| From 22 to 35 | From 26.0 to 28.0 | From 1:0 to 1:0.5 | From 6 to 8 | From 120 to 160 |
| From 15 to 22 | From 31.0 to 33.0 | From 1:0 to 1:0.3 | From 6 to 8 | From 75 to 125 |

### Operation: Apparatus, FIG. 5

The integral version of the embodiment mentioned above is used in conjunction with a rod, the front end has a leader and a fly connected to it. The caster performs the necessary ‘C’ shape manipulation before casting forward. An alternative setup using the embodiment from FIG. 5 has the fly line head connected to a running line (not shown) to the rear end, and has a fly line (not shown) or a leader with a fly attached (not shown) connected to the front end.

1. An fly line head, to be used in conjunction with a rod which a user communicates with, comprising a certain length of the line having a forward portion for an optional attachment of a leader and a rear portion for attachment to a spool of a reel, the fly line head comprising a Back Loop, a Back Taper, a Belly, a Funnel Taper, a Front Taper and a Front Loop. The Funnel Taper has two ends; an end smooth connecting to the Belly and the other end smooth connecting to the Front Taper.

2. The fly line head of claim 1 wherein the total length of the fly line head ranges between 62 feet and 73 feet.

3. The fly line head of claim 2 wherein the Belly weight ranges between 21.5 grains per foot and 23.5 grains per foot.

4. The fly line head of claim 2 wherein the forward slope of the Funnel Taper ranges between a vertical unit of 2 to a horizontal unit of 0 and a vertical unit of 1 to a horizontal unit of 0.5 and the unit weight change between two ends of the Funnel Taper ranges between 6 grains per foot and 8 grains per foot.

5. The fly line head of claim 2 wherein the total weight of the Front Taper ranges between 390 grains and 420 grains.

6. The fly line head of claim 1 wherein the total length of the fly line head ranges between 50 feet and 62 feet.

7. The fly line head of claim 6 wherein the Belly weight ranges between 22.0 grains per foot and 24.0 grains per foot.

8. The fly line head of claim 6 wherein the forward slope of the Funnel Taper ranges between a vertical unit of 1 to a horizontal unit of 0 and a vertical unit of 1 to a horizontal unit of 0.5 and the unit weight change between two ends of the Funnel Taper ranges between 6 grains per foot and 8 grains per foot.

9. The fly line head of claim 6 wherein the total weight of the Front Taper ranges between 343 grains and 377 grains.

10. The fly line head of claim 1 wherein the total length of the fly line head ranges between 42 feet and 50 feet.

11. The fly line head of claim 10 wherein the Belly weight ranges between 23.5 grains per foot and 25.5 grains per foot.

12. The fly line head of claim 10 wherein the forward slope of the Funnel Taper ranges between a vertical unit of 1 to a horizontal unit of 0 and a vertical unit of 1 to a horizontal unit of 0.5 and the unit weight change between two ends of the Funnel Taper ranges between 6 grains per foot and 8 grains per foot.

13. The fly line head of claim 10 wherein the total weight of the Front Taper ranges between 300 grains and 340 grains.

14. The fly line head of claim 1 wherein the total length of the fly line head ranges between 35 feet and 42 feet.

15. The fly line head of claim 14 wherein the Belly weight ranges between 24.0 grains per foot and 26.0 grains per foot.

16. The fly line head of claim 14 wherein the forward slope of the Funnel Taper ranges between a vertical unit of 1 to a horizontal unit of 0 and a vertical unit of 1 to a horizontal unit of 0.5 and the unit weight change between two ends of the Funnel Taper ranges between 6 grains per foot and 8 grains per foot.

17. The fly line head of claim 14 wherein the total weight of the Front Taper ranges between 250 grains and 290 grains.

18. The fly line head of claim 1 wherein the total length of the fly line head ranges between 22 feet and 35 feet.

19. The fly line head of claim 18 wherein the Belly weight ranges between 26.0 grains per foot and 28.0 grains per foot.

20. The fly line head of claim 18 wherein the forward slope of the Funnel Taper ranges between a vertical unit of 1 to a horizontal unit of 0 and a vertical unit of 1 to a horizontal unit of 0.5.

21. The fly line head of claim 18 wherein the unit weight change between two ends of the Funnel Taper ranges between 6 grains per foot and 8 grains per foot.

22. The fly line head of claim 18 wherein the total weight of the Front Taper ranges between 120 grains and 160 grains.
